(19) United States
(12) Patent Application Publication
(10) Pub. No.: US 2009/0044847 A1
(43) Pub. Date: Feb. 19, 2009

(54) Ergonomic cane handle

(75) Inventor: Hernan Barangan, Santa Monica, CA (US)

Correspondence Address: Cislo & Thomas LLP, 1333 2nd Street, Suite #500, Santa Monica, CA, 90401-4110, US

(73) Assignee: Momentlight LLC

(21) Appl. No.: 12/214,148

(22) Filed: Jun. 17, 2008

Related U.S. Application Data
(63) Continuation-in-part of application No. 11/838,889, filed on Aug. 15, 2007, now abandoned.

(51) Int. Cl. A61H 3/02

(52) U.S. Cl. 135/72

(57) ABSTRACT

A handle for a cane that includes a bulbous protrusion formed on the underside of the handle, against the shaft. The shape and dimensions of the bulbous protrusion better accommodates the natural spacing between a user's fingers. The bulbous protrusion's location against the shaft and the palm support also provides for better control of the shaft of the cane.

### CROSS-REFERENCE TO RELATED APPLICATION

This patent application claims the benefit of U.S. patent application Ser. No. 11/838,889, entitled “Ergonomic Cane Handle with an Ovoid Form Against the Shank and Under the Handle for Better Finger Placement, Cane Control and Improved Grip,” filed Aug. 15, 2007, which application is incorporated in its entirety here by this reference.

### TECHNICAL FIELD

The invention concerns an improved handle for an assistive walking cane.

### BACKGROUND

Previous designs for cane handles employ a generally uniform girth of material through the shaft of the cane to the handle. The most common handles available are crook handles, derby handles and ‘fritz’ handles. The crook handle, being the most rudimentary, consists only of a hook shape of uniform girth throughout. This places the user's center of balance improperly at a point behind the shaft of the cane.

Some handles extend from the shaft not in a rounded hook shape but at a 90 degree angle. The user's weight is then placed over the handle and not the shaft of the cane. These handles may have a rounded aspect to their underside but the rounded aspect is not a form against the shaft. Therefore, it does not add to the stability of the user's grip on the shaft of the cane. Some cane handles correct the alignment problem by placing the user's arm in line with the shaft of the cane. But these designs utilize a handle that extends from the shaft at a girth that matches the girth of the shaft. It is believed that handles extending from the shaft at a 90 degree angle give the user very little control over the direction of the cane, enabling for more “roll” of the handle within the grip of the user. Such “roll” results in instability in the placement of the cane to the left and right of the user's grip.

Other handles give the user better control of the shaft, but still only provide the fingers with a grip that continues in girth from the shaft to the handle. This does not completely solve the problem of “roll” and does little to provide the fingers with adequate spacing and placement throughout the grip.

In the case of all these grips, the fingers end up cramped together on the handle. A user tightening his or her hold on these handles does not necessarily get greater control of the cane, because the force is not properly distributed to the cane through the handle. All fingers clamping as one to a tubular handle and shaft do little against the forces that pull the cane and cause the handle to “roll” in the user's grip.

Moreover, these canes all have a similar trait—the handles maintain a circumference from shaft towards tip that disregards finger length. On the human hand, the longest finger is the middle finger, followed by the ring finger, descending in order to the pinky finger. Some cane handles force the index finger to rest on the shaft of the cane, while the remaining fingers grip the handle. With handles that extend from the shaft in uniform girth, the individual fingers of different length must all deal with the same circumference handle—each to varying degrees of efficiency.

Thus, there is still a need for a cane that provides true support and alignment, and the necessary grip and cane control that can keep a user walking far longer than current walking canes.

### SUMMARY

The ergonomic cane handle of the present invention comprises a palm support; a front end adjacent to the palm support, wherein the front end comprises a neck extending in a first direction away from the palm support; a back end opposite the front end and adjacent to the palm support, a first side adjacent to the front end, the back end, and the palm support; a second side opposite the first side and adjacent to the front end, the back end, and the palm support; a finger grip portion opposite the palm support and adjacent to the first side, the second side and the back end; and a bulbous protrusion opposite the palm support and adjacent to the front end, the first side, the second side and the finger grip portion, wherein the bulbous protrusion comprises a primary axis along which a length of the bulbous protrusion is defined, a secondary axis, perpendicular to the primary axis, along which a height of the bulbous protrusion is defined, and a tertiary axis, perpendicular to the primary axis and the secondary axis, along which a width of the bulbous protrusion is defined, wherein the length is at least the same measurement as the width and the height. Preferably, the bulbous protrusion is ovoid in shape.

The inclusion of an ovoid shape on the underside of the handle, against the shaft provides numerous advantages to the user. For example, the problem of “roll”—the handle twisting out of the grip of the user—is solved by the ovoid shape incorporated into the handle, against the shaft. The palm and fingers of the hand meet greater force distribution through the form of the handle. Thus, the user can keep the cane shaft better aligned with the arm and the ground, providing the user with better stability.

The bulbous protrusion positioned against the shaft of the cane also distributes hand-grip-force more efficiently to the shaft, even further improving control of the cane overall.

The increased circumference of the bulbous protrusion gives the middle finger a more fitting grip at that finger's position on the cane handle. Since the ovoid shape decreases in circumference towards the back end, the grip of the ring finger is accordingly also accounted for, as well as the grip of the pinky finger. The force exerted through all fingers is more perfectly transmitted to the cane, and the fingers are not left cramped together. Toward the back end of the handle, the bulbous protrusion tapers to a narrow bridge where the pinky finger can better contribute to grip.

As the curvature of the ovoid shape meets the shaft of the cane, placement of the thumb and forefinger along the shaft are also accounted for, maximizing their grip along the cane.

The handle of the cane also extends up to better fill the palmer arch of the hand, keeping the wrist in better alignment with the arm, cane and ground.

These objects, as well as other objects and advantages of the present invention, will become clearer through consideration of the following description and accompanying designs.

### BRIEF DESCRIPTION OF THE DRAWINGS

FIG. 1A is a front perspective view of an embodiment of the ergonomic cane handle of the present invention;

FIG. 1B is a rear perspective view of an embodiment of the ergonomic cane handle;

FIG. 2A is a side view of an embodiment of the ergonomic cane handle;

FIG. 2B is another side view of an embodiment of the ergonomic cane handle;

FIG. 3A is a bottom perspective view of an embodiment of the ergonomic cane handle;

FIG. 3B is a top view of an embodiment of the ergonomic cane handle.

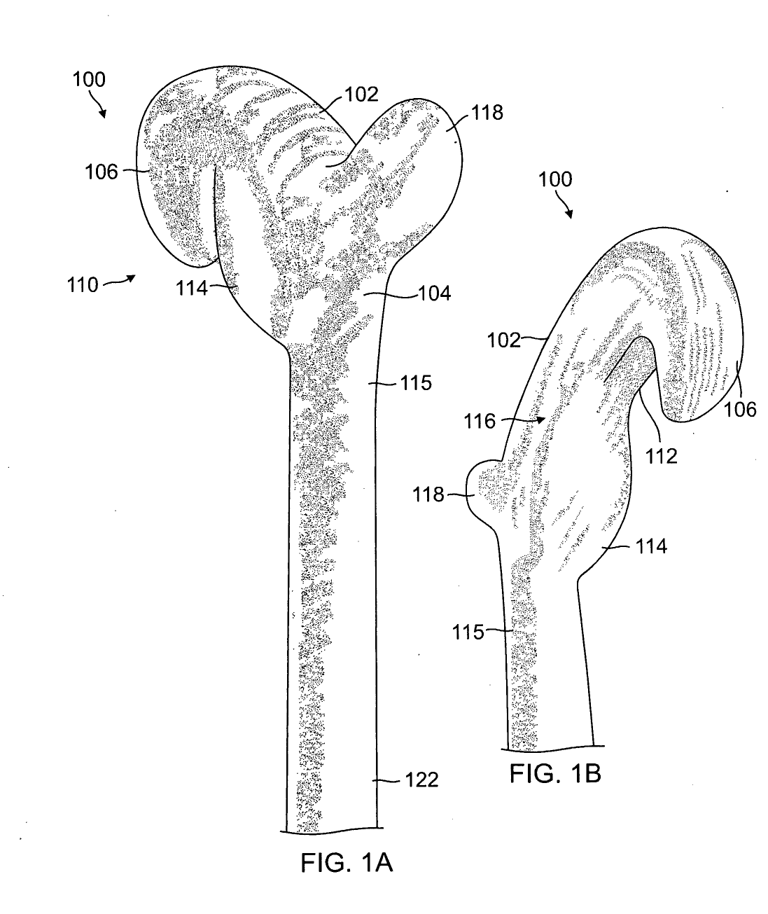

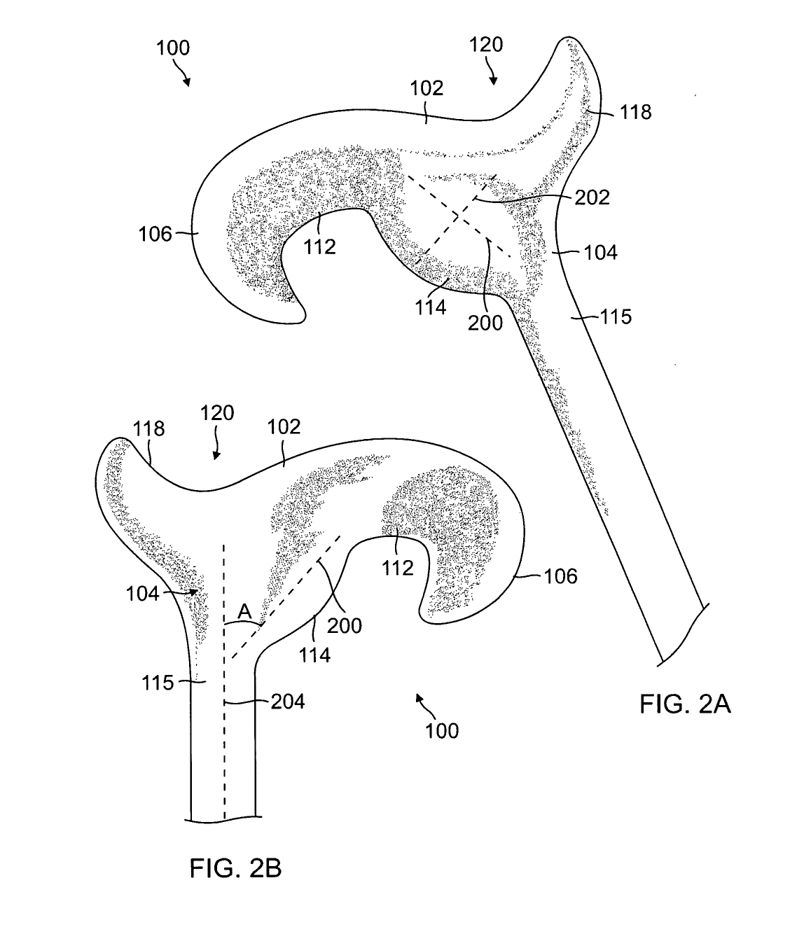

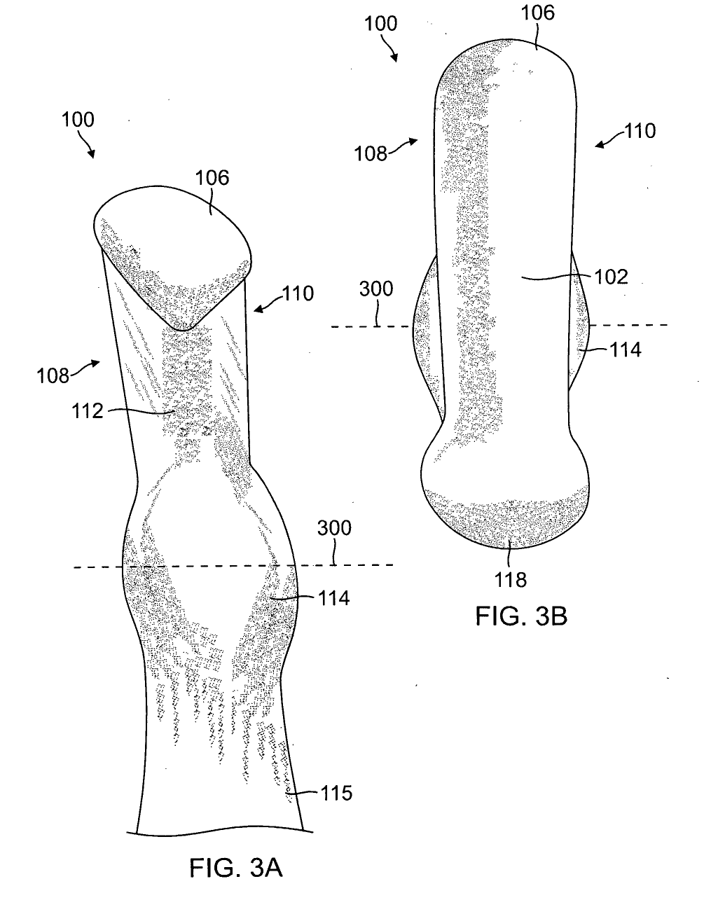

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the features of the invention in connection with the illustrated embodiments. It is to be understood, however, that the same or equivalent functions and sequences may be accomplished by different embodiments that are also intended to be encompassed within the spirit and scope of the invention.

A cane handle 100 providing an ergonomic grip has a palm support 102, a front end 104 adjacent to the palm support 102, a back end 106 opposite the front end 104 and adjacent to the palm support 102, a first side 108 adjacent to the front end 104, the back end 106, and the palm support 102, a second side 110 opposite the first side 108 and adjacent to the front end 104, the back end 106, and the palm support 102, a finger grip portion 112 opposite the palm support 102 and adjacent to the first side 108, the second side 110 and the back end 106, and a bulbous protrusion 114 opposite the palm support 102 and adjacent to the front end 104, the first side 108, the second side 110 and the finger grip portion 112. The front end 104 may comprise a neck 115 extending in a first direction away from the palm support 102 along a longitudinal axis 204.

The bulbous protrusion 114 improves the ergonomic design over typical cane handles by compensating for the fact that the fingers on a single hand are of different lengths. In particular, the bulbous protrusion 114 positioned at the front end 104 may accommodate the index finger and the middle finger or the middle finger and ring finger, depending on how the user grasps the cane. It is contoured to afford maximum grip to the hand and fingers, while aligning the user's hand and arm directly over the shaft of the cane. The shaft 122 of the cane widens at the neck 115 where the bulbous protrusion 114 begins. The handle 100 then extends up from the bulbous protrusion 114 at an angle to fill the palmer arch of the hand. The bulbous protrusion 114 at the base of the handle 100 provides better control of the cane shaft 122 direction and stability. In addition, it produces more accurate spacing of the fingers along the grip 112. The bulbous protrusion 114 tapers back to the underside of the handle 100 where the handle 100 extends to the grip 112 that is useful for the pinky finger in gripping the cane handle 100. The grip 112 may be square shaped, trapezoidal, curved, cylindrical, oblong, tapered, or any other shape providing comfort to the pinky.

The bulbous protrusion 114 is generally an ovoid shape comprising a primary axis 200 defining a length of the bulbous protrusion 114, a secondary axis 202 defining a height of the bulbous protrusion 114, and a tertiary axis 300 defining a width of the bulbous protrusion 114, wherein the length is greater than the width and the height. In some embodiments, the bulbous protrusion 114 may be spherical, therefore, the length, width, and height may be the same measurements.

In some embodiments, the primary axis 200 is provided at an angle A relative to a longitudinal axis 204 defined by the neck 115 and shaft 122 of the cane. The neck portion 115, when in general use, may be perpendicular to the ground, therefore, parallel with the shaft 122 of a cane. The angle A between the primary axis 200 and the longitudinal axis 204 of the cane may be between approximately 25 degrees and 75 degrees. Preferably, the primary axis 200 and the longitudinal axis 204 define an angle A between approximately 30 degrees and approximately 60 degrees. More preferably, the primary axis 200 and the longitudinal axis 204 define an angle A of approximately 45 degrees. Providing such an angle A better accommodates the fingers because the bulbous protrusion 114 is thickest in the center of the bulbous protrusion 114 and narrows as it approaches the front end 104 and the grip portion 112. This allows the middle finger, which is generally the longest finger, to rest on the thickest portion of the bulbous protrusion 114 while the index finger rests on a narrower or thinner portion of the bulbous protrusion 114 thereby providing a comfortable grip.

In addition, the placement of the bulbous protrusion 114 at the front end 104 and adjacent to the cane shaft 122 allows the bulbous protrusion 114 to provide added support to the palm support 102, by directing any downward force applied to the middle or rear portion of the palm support 102 into the neck 115 or shaft 122 of the cane.

The bulbous protrusion 114 may come in a variety of sizes to accommodate hands of different sizes. In some embodiments, the length measures between approximately 0.5 inch and approximately 2.5 inches. Preferably, the length measures between approximately 1.0 inch and approximately 2.0 inches. More preferably, the length measures between approximately 1.3 inches and 1.8 inches. The width may measure between approximately 0.5 inch and approximately 1.8 inches. Preferably, the width measures between approximately 1.2 inches and approximately 1.4 inches. The height may measure between approximately 0.5 inch and approximately 1.5 inches. Preferably, the height measures between approximately 0.8 inch and approximately 1.2 inches.

In some embodiments, the cane handle 100 may further comprise a groove 116 on the first side 108, between the palm support 102 and the bulbous protrusion 114. The groove 116 provides for an ergonomic placement of the thumb. In some embodiments, the cane handle 100 may comprise a second groove on the second side 110 for ergonomic placement of the index finger.

To further provide a comfortable, ergonomic grip, the first side 108 and second side 110 may taper from the palm support 102 to the finger grip 112. This provides a broad palm support to fully support the palm while providing a narrow grip area to allow the fingers, particularly the ring finger and/or the pinky finger to easily grasp the grip portion 112.

In some embodiments, the cane handle 100 comprises a shoulder 118 at the front end 104 defining a web groove 120 to provide support at the webbing between the index finger and the thumb. This prevents the hand from slipping off the cane handle at the front end 104.

When a cane comprising the ergonomic cane handle is in normal use, the palm support 102 is generally parallel with the ground. In some embodiments, the palm support 112 comprises an upward curvature from the front end 104 to the back end 106. This upward curvature accommodates the shape of the butt of the palm of the hand, just below the thumb.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A cane handle comprising:
a. a palm support;
b. a front end adjacent to the palm support, wherein the front end comprises a neck extending in a first direction away from the palm support;
c. a back end opposite the front end and adjacent to the palm support;
d. a first side adjacent to the front end, the back end, and the palm support;
e. a second side opposite the first side and adjacent to the front end, the back end, and the palm support; and
f. a finger grip portion opposite the palm support and adjacent to the first side, the second side and the back end; and
g. a bulbous protrusion opposite the palm support and adjacent to the front end, the first side, the second side and the finger grip portion, wherein the bulbous protrusion comprises a primary axis defining a length of the bulbous protrusion, a secondary axis defining a height of the bulbous protrusion, and a tertiary axis defining a width of the bulbous protrusion, wherein the length is greater than the width and the height.

2. The cane handle of claim 1, wherein the primary axis and the neck define an angle of approximately 25 degrees and 75 degrees.

3. The cane handle of claim 2, wherein the primary axis and the neck define an angle between approximately 30 degrees and approximately 60 degrees.

4. The cane handle of claim 3, wherein the primary axis and the neck define an angle of approximately 45 degrees.

5. The cane handle of claim 2, wherein
a. the length measures between approximately 1 inch and approximately 2.5 inches;
b. the width measures between approximately 0.5 inch and approximately 1.8 inches; and
c. the height measures between approximately 0.5 inch and approximately 1.5 inches.

6. The cane handle of claim 5, wherein
a. the length measures between approximately 1.3 inches and approximately 1.8 inches;
b. the width measures between approximately 1.2 inches and approximately 1.4 inches; and
c. the height measures between approximately 0.8 inch and approximately 1.2 inches.

7. The cane handle of claim 1, further comprising a groove on the first side, between the palm support and the bulbous protrusion.

8. The cane handle of claim 7, wherein the first side and second side tapers from the palm support to the finger grip.

9. The cane handle of claim 8, wherein the palm support comprises a shoulder at the front end defining a web groove.

10. The cane handle of claim 9, wherein the palm support comprises an upward curvature from the front end to the back end.

11. A cane handle comprising:
a. a palm support;
b. a front end adjacent to the palm support, wherein the front end comprises a neck extending in a first direction away from the palm support;
c. a back end opposite the front end and adjacent to the palm support;
d. a first side adjacent to the front end, the back end, and the palm support;
e. a second side opposite the first side and adjacent to the front end, the back end, and the palm support; and
f. a finger grip portion opposite the palm support and adjacent to the first side, the second side and the back end; and
g. a bulbous protrusion opposite the palm support and adjacent to the front end, the first side, the second side and the finger grip portion, wherein the bulbous protrusion comprises a primary axis defining a length of the bulbous protrusion, a secondary axis defining a height of the bulbous protrusion, and a tertiary axis defining a width of the bulbous protrusion, wherein the length is at least the same measurement as the width and the height.

12. The cane handle of claim 11, wherein
a. the length measures between approximately 0.5 inch and approximately 2.5 inches;
b. the width measures between approximately 0.5 inch and approximately 1.8 inches; and
c. the height measures between approximately 0.5 inch and approximately 1.5 inches.

13. The cane handle of claim 12, wherein
a. the length measures between approximately 1.3 inches and approximately 1.8 inches;
b. the width measures between approximately 1.2 inches and approximately 1.4 inches; and
c. the height measures between approximately 0.8 inch and approximately 1.2 inches.

14. The cane handle of claim 13, wherein the primary axis and the neck define an angle of approximately 25 degrees and 75 degrees.

15. The cane handle of claim 14, wherein the primary axis and the neck define an angle between approximately 30 degrees and approximately 60 degrees.

16. The cane handle of claim 11, further comprising a groove on the first side, between the palm support and the bulbous protrusion.

17. The cane handle of claim 16, wherein the first side and second side tapers from the palm support to the finger grip.

18. The cane handle of claim 17, wherein the palm support comprises a shoulder at the front end defining a web groove.

19. The cane handle of claim 18, wherein the palm support comprises an upward curvature from the front end to the back end.

20. A cane handle comprising:
a. a palm support;
b. a front end adjacent to the palm support, wherein the front end comprises a neck extending in a first direction away from the palm support;
c. a back end opposite the front end and adjacent to the palm support;
d. a first side adjacent to the front end, the back end, and the palm support;
e. a second side opposite the first side and adjacent to the front end, the back end, and the palm support;
f. a finger grip portion opposite the palm support and adjacent to the first side, the second side and the back end, wherein the first side and second side taper from the palm support to the finger grip, wherein the palm support comprises a shoulder at the front end defining a web groove, and wherein the palm support comprises an upward curvature from the front end to the back end;
g. a bulbous protrusion opposite the palm support and adjacent to the front end, the first side, the second side and the finger grip portion, wherein the bulbous protrusion comprises a primary axis defining a length of the bulbous protrusion, a secondary axis defining a height of the bulbous protrusion, and a tertiary axis defining a width of the bulbous protrusion, wherein the primary axis and the neck define an angle between approximately 30 degrees and approximately 60 degrees, and wherein the length measures between approximately 1 inch and approximately 2.5 inches, the width measures between approximately 0.5 inch and approximately 1.8 inches, and the height measures between approximately 0.5 inch and approximately 1.5 inches to provide an ergonomic grip; and
h. a thumb groove on the first side, between the palm support and the bulbous protrusion to provide an ergonomic placement for a thumb.
